(19) United States
(12) Patent Application Publication
(10) Pub. No.: US 2008/0085034 A1
(43) Pub. Date: Apr. 10, 2008

(54) Method and imaging system to compensate for patient movements when recording a series of medical images

(75) Inventors: Peter Hildebrandt, Numberg (DE); Michael Pflaum, Rottenbach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/973,247

(22) Filed: Oct. 5, 2007

(30) Foreign Application Priority Data
Oct. 9, 2006 (DE) 10 2006 047 719.7

(51) Int. Cl. G06K 9/00

(52) U.S. Cl. 382/107

(57) ABSTRACT

The present invention relates to a method and imaging system to compensate for patient movements when recording a series of medical images, in which a number of images of an area of a patient to be examined are recorded at intervals and are related to one another, especially for movement compensation in Digital Subtraction Angiography (DSA) or roadmapping (RDMP) in the abdominal area. A plurality of breath-triggered mask images is recorded during a breathing cycle. Frilling images are recorded with the same triggering and mask images and filling images which are recorded for the same breathing states are subtracted from each other in realtime and the difference recordings are displayed in realtime.

### CROSS REFERENCE TO RELATED APPLICATIONS

This application claims priority of German application No. 10 2006 047 719.7 filed Oct. 09, 2006, which is incorporated by reference herein in its entirety.

### FIELD OF THE INVENTION

The present invention relates to a method to compensate for patient movements when recording a series of medical images in which a number of images of an area under examination of the patient are taken at intervals with an imaging system and are compared to one another, as is the case for example in Digital Subtraction Angiography (DSA) or roadmapping. The invention further relates to a medical imaging system with radiation source, detector, patient bed, image processing unit and image display unit which is embodied to execute the method.

### BACKGROUND OF THE INVENTION

In a main area of application of the present method, the area of digital subtraction angiography, blood vessels of the human body are recorded with an imaging system, in this case an x-ray system, and displayed. With this method series of x-ray images of the area under examination of interest for the patient are recorded while a contrast medium is injected to emphasize the vessels (filling images). Furthermore an image of the area under investigation is recorded without injecting a contrast medium (mask image). By digitally subtracting the mask image from the relevant filling images, subtraction images are obtained on which only the vessels are visible while overlays from other x-ray-absorbing structures, such as for example bones, disappear because of the subtraction.

The subtraction of the images however requires these images to be recorded under the same geometrical conditions so that they cover the same area. As a result of motion of the recorded structures between the individual recordings the result can be disruptive motion artefacts in the subtracted images. These can be caused by the patient moving between the recording of the mask image and the recordings of the filling images. A consequence of these movements can be that the resulting subtraction image can no longer be used for the diagnosis. Thus it can occur in practice that, because of these types of motion artefacts, disrupted subtraction images have to be repeated. This often involves additional effort in time and contrast media as well as exposure of the patient to additional radiation.

A method known as roadmapping is a technique associated with digital subtraction angiography. This technique is applied for selective catheterization of vessels in interventional therapy. With such vessel interventions the current position of an x-ray-absorbing catheter is shown by x-ray fluoroscopy in a two-dimensional image. To also enable the blood vessel to be recognized as what is known as a roadmap an image is recorded at the start of the intervention for which a small amount of contrast medium has been injected. This image is retained as a mask image. The following fluoroscopy images obtained without injection of a contrast media are subtracted from the mask image in each case. In this way subtraction images are obtained on which the catheter is visible as a bright object against the dark blood vessel and the background has been eliminated by subtraction.

Like digital subtraction angiography, roadmapping is also disrupted in the same way by motion of the imaged structures during recording of a series of images. For motion between the recording of the mask image and the relevant fluoroscopy image two problems arise here however. One is that the background is no longer correctly subtracted so that image artefacts occur. The other is that it can occur that the position determined by the image of the catheter relative to the blood vessel shown is not correct. This serious error can for example result in the image showing a catheter outside the vessel although it is actually located inside the vessel. In an extreme case such incorrect representations can lead to errors in catheter control and result in injuries to the vessel. If the patient moves during the intervention it is therefore frequently necessary for the roadmap to be refreshed by recording a new mask image. This requires additional time and uses up more contrast means and is associated with a higher dose of radiation for the patient.

Different solutions are currently known for avoiding or for reducing this problem. The following three types of approach to solutions can thus be identified.

Patient-linked solutions aim to avoid movement of the patient during image recording. Thus for example, during thorax examinations, the patient can be trained to hold their breath while the series of images is being recorded. A further option is to avoid a number of sources of motion artefacts by a full anaesthetic. A disadvantage of patient-linked methods lies in the fact that they are only partly effective or cannot always be used. A full anaesthetic for example involves many risks and is thus not medically advised for many applications of digital subtraction angiography. In addition, even with a full anaesthetic, a number of sources of motion artefacts, such as breath movement, are still present.

For the solutions which are linked to how the images are recorded the image recording is executed so that motion artefacts are minimized. Previously the main method known in this area has been the gating method in which the recording is coupled with a physiological measurement. Thus for example with ECG gating images of only acquired in a particular heart phase, to compensate for heart movements. Gating methods are however only usable for a few specific applications and can only avoid motion artefacts caused by specific sources for which physiological signals can be measured.

A further approach to a solution for avoiding a motion artefacts consists of retrospective image processing of the recorded images. With these techniques the aim is to use image processing to obtain a better match between mask image and filling image. The simplest technique used is known as pixel shifting or subpixel shifting, in which the user shifts the mask image in relation to the filling image manually in two dimensions until a minimization of the motion artefacts is obtained in the subtraction image. This method is implemented in all commercial angiography systems. Automatic methods which define the best match on the basis of quantifiable similarity measures are present in a few commercial angiography systems. More complex methods do not use global pixel shifting over the entire area of the image but optimize local areas of the image separately from one another, as described for example in U.S. Pat. No. 4,870,692 A. Furthermore scientific literature proposes numerous more expensive methods for movement correction. These essentially involve optimization methods in which attempts are made to find the transformation between masking image and a filling image which results in the fewest motion artefacts. Further examples of retrospective image processing can be found in the publications “Motion compensated digital subtraction angiography”, M. Hemmendorff et al., SPIE '99, San Diego USA, Proceedings of SPIE's International Symposium on Medical Imaging 1999; Meijering E. H. et al., “Reduction of patient motion artefacts in digital subtraction angiography: evaluation of a fast and fully automatic technique”, Radiology, 2001 April; 219(1): pp. 288-293; or “Retrospective Motion Correction in Digital Subtraction Angiography: A Review”, Erik H. W. Meijering et al., IEEE Transactions on Medical Imaging, Vol. 18, No. 1, January 1999, Pages 2-21.

Retrospective image processing can however only approximately compensate for motion. Not all motion can be corrected. Even when the method is restricted to a correction of 6 degrees of freedom corresponding to the rotation and translation of a rigid body, the motion cannot be uniquely determined from the two-dimensional images. Furthermore the complicated image processing methods demand extensive processing power and are thus difficult to implement in realtime. Manual methods for image processing (pixel shifting) need user interaction and can demand significant amounts of time. They can also basically only be used for retrospective improvement of recorded DSA images since with roadmapping there is barely time for interaction.

### SUMMARY OF THE INVENTION

Using this prior art as a starting point, the object of the present invention is to specify a method as well as an associated imaging system to compensate for the motion of patients, especially in the abdominal area, when recording a series of images in medical imaging, with which the motion of the patient can be compensated for while the images are being recorded without time-consuming user interaction, with the method being able to be implemented in realtime. The method and the associated imaging system should in particular improve image results in a digital subtraction angiography and roadmapping with the lowest possible outlay as regards the operator's time.

The object is achieved by the method as well as by the arrangement in accordance with the claims. Advantageous embodiments of the method and of the arrangement are the subject of subclaims or can be taken from the subsequent description as well as the exemplary embodiments.

In the present method for compensating for patient motion when recording a series of images in medical imaging, in which a number of images of the area under examination of a patient are recorded at intervals with an imaging system and are related to one another, a plurality of breath-triggered mask images are recorded during a breathing cycle. With the same triggering filling images are recorded and mask images and filling images which are recorded for the same breathing states are subtracted from each other in realtime and the difference images are displayed in realtime. A much better match between the current filling image and the mask image is achieved in this way. Depending on the application between 2 and 40 mask images are recorded in one breathing cycle. The subtraction of specific mask images from filling images taken in an identical breathing state is a live process in one embodiment of the present invention, i.e. during the recording of the filling images, so that especially in the pathfinder method for example a secure catheter guidance is possible. Mask images and filling images and their difference are stored in the image processing system.

The method can be used especially for motion compensation in digital subtraction angiography or with roadmapping to obtain individual images for subtraction which cover as much of the same area as possible. It is precisely in the abdominal area that the patient's movements especially with diaphragm breathing, are comparatively large. With longer interventions it is not possible to get the patient to hold their breath for so long, for example, when a catheter is being set. It is an absolute necessity here to subtract mask images and filling images taken in the same breathing state from each other, since otherwise an elimination of the background becomes impossible and also the mapping of the location of a catheter in relation to a vein can be incorrectly reproduced.

The present method, by contrast with most previously known methods of motion correction, manages without interaction with the operator. The proposed method only requires a breath sensor to be accommodated on the patient where necessary. Thereafter no further user interaction is required for motion compensation. The principle of previous methods for retrospective image processing dictates that they only operate approximately. It is barely possible to correct large movements using these methods, and small movements can only be approximately corrected. The proposed method operates with high precision even for large movements, so that the need to record a mask image more than once is avoided. The saves time, contrast means and reduces the applied x-ray dose in the case of x-ray image recording. The present method also makes it possible in particular cases to dispense with sedating or anaesthetizing the patient merely for the purpose of minimizing motion artefacts.

Naturally, with the present method, after the at least approximate compensation of the movement, retrospective image processing methods can also be used in order to further improve the image results. The approximate compensation by modifying the geometrical circumstances of the imaging system can be used in this case to compensate for rough movements, while remaining small errors can be rectified by retrospective image processing.

The present imaging system comprises at least a radiation source and a detector, a patient support, a control unit, an image processing unit and an image display unit. A breath sensor is provided for detecting the patient's breathing cycle. A trigger device is used to trigger the recording times for the mask and filling images with the breathing cycle. In this case between 2 and 40 images are recorded during one breathing cycle. In the image processing unit the subtraction of filling and mask images is undertaken directly during the recording of the filling images, so that the difference recording is shown live.

### BRIEF DESCRIPTION OF THE DRAWINGS

The present method as well as the associated device are explained in more detail again below with reference to an exemplary embodiment in connection with the drawing. The drawing shows an example for a C-arm device as an imaging system for executing the present method.

### DETAILED DESCRIPTION OF THE INVENTION

The present method is described below with reference to an x-ray angiography system for applications in neuro-radiology. The method can naturally also be used in other fields in which digital subtraction angiography and/or roadmapping are employed. The present method can also be used with other medical imaging techniques involving having to record a series of images and relate them to one another.

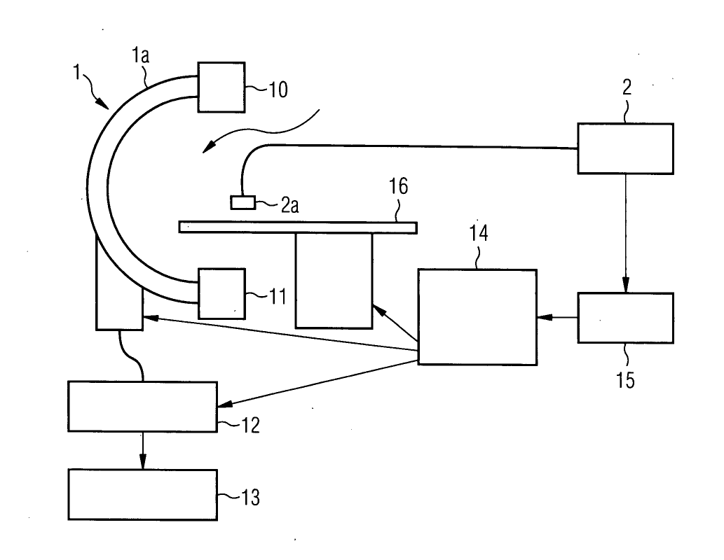

An x-ray angiography system 1 for neuro-radiology, which is shown schematically in FIG. 1, is used to record the images. The x-ray angiography system 1 includes a C-arm 1a which can be rotated around two axes, to which an x-ray tube 10 and a detector 11 arranged opposite the x-ray tube are attached, an image processing unit 12 and an image display unit 13. Furthermore this system includes the motor-driven adjustable patient table 16, a control unit 14 for image recording control as well as the compensation unit 15. Rotation of the C-arm 1a allows different projections of the area under examination of the patient supported on the patient table 16 to be recorded as two-dimensional images. With the present method a breath sensor 2a is used to record the patient's breathing system. The breath sensor 2a is connected to a trigger device 2 which determines the point of recording the mask and filling images during a breathing cycle. Usually between 2 and 40 images are recorded per breathing cycle. The masking images are stored digitally and after the injection of a contrast medium filling images are recorded with the same triggering with which the times of the recording of the mask images were determined. This means that mask and filling images which have been recorded with the same breathing states respectively are obtained. Their subtraction leads to an optimum elimination of image components which are not of interest.

1.-6. (canceled)

7. A method for compensating a movement of a patient when recording a series of images of the patient by an imaging system, comprising:
recording a plurality of mask images triggered by a plurality of breathing states during a breathing cycle of the patient;
recording a plurality of filling images triggered by a plurality of identical breathing states during a further breathing cycle of the patient;
subtracting the mask images and the filling images which are recorded at the same breathing states from each other in realtime; and
displaying the subtracted images in realtime.

8. The method as claimed in claim 7, wherein the mask images are recorded without injecting a contrast medium into the patient.

9. The method as claimed in claim 7, wherein the filling images are recorded while a contrast medium is injected into the patient.

10. The method as claimed in claim 7, wherein the breathing states are detected by a breath sensor.

11. The method as claimed in claim 7, wherein the mask images and the filling images are subtracted from each other in a live mode of the imaging system.

12. The method as claimed in claim 7, wherein the number of images which are recorded per breathing cycle is in a range between 2 and 40.

13. The method as claimed in claim 7, wherein the images are recorded at intervals and are related to each other.

14. The method as claimed in claim 7, wherein the movement to be compensated is in a digital subtraction angiography or in a roadmapping in an abdominal area of the patient.

15. The method as claimed in claim 7, wherein the mask images, the filling images, and the subtracted images are stored.

16. An imaging system, comprising:
a radiographic source that emits radiations to a patient;
a radiation detector that records a plurality of images of the patient comprising a plurality of mask images and a plurality of filling images during breathing cycles of the patient;
a breath sensor that detects a plurality of breathing states in the breathing cycles of the patient;
a trigger device that triggers the recoding of the mask images and the filling images at identical breathing states of the breathing cycles of the patient;
an image processing unit that in realtime subtracts the mask images and the filling images which are recorded at the same breathing states from each other; and
an image display unit that displays the subtracted images in realtime.

17. The imaging system as claimed in claim 16, wherein the mask images are recorded without injecting a contrast medium into the patient.

18. The imaging system as claimed in claim 16, wherein the filling images are recorded while a contrast medium is injected into the patient.

19. The imaging system as claimed in claim 16, wherein the mask images and the filling images are subtracted from each other in a live mode of the imaging system.

20. The imaging system as claimed in claim 16, wherein the number of images which are recorded per breathing cycle is in a range between 2 and 40.
